(19) United States
(12) Patent Application Publication
(10) Pub. No.: US 2008/0189660 A1
(43) Pub. Date: Aug. 7, 2008

(54) Information Processing Apparatus, Information Processing Method, and Information Processing Program

(76) Inventor: Masao Nakagawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/951,402

(22) Filed: Dec. 6, 2007

(30) Foreign Application Priority Data
Dec. 8, 2006 (JP) 2006-331472

(51) Int. Cl. G06F 3/048

(52) U.S. Cl. 715/840

(57) ABSTRACT

An information processing apparatus that controls reproduction of first content and second content to simultaneously reproduce the contents is disclosed. The information processing apparatus includes: first reproduction control means for controlling reproduction of the first content; selecting means for selecting, from first metadata attached to the first content, first theme metadata representing a theme of the first content and the second content to be reproduced; second reproduction control means for controlling reproduction of the second content when the first theme metadata and second metadata attached to the second content are the same; and comparing means for comparing second theme metadata selected by the selecting means from metadata of the second metadata different from the first theme metadata and third metadata attached to third content, wherein the first reproduction control means controls reproduction of the third content when the second theme metadata and the third metadata are the same.

### CROSS REFERENCES TO RELATED APPLICATIONS

The present invention contains subject matter related to Japanese Patent Application JP 2006-331472 filed in the Japanese Patent Office on Dec. 8, 2006, the entire contents of which being incorporated herein by reference.

### BACKGROUND OF THE INVENTION

1. Field of the Invention

The present invention relates to an information processing apparatus, an information processing method, and an information processing program, and, more particularly to an information processing apparatus, an information processing method, and an information processing program for continuously reproducing contents.

2. Description of the Related Art

There is proposed a content reproducing apparatus that simultaneously reproduces, during reproduction of contents, content reproduced according to a taste of a user and other contents related to the content.

For example, it is proposed to create recommendation information for recommending sub-contents, which should be associated with main content, from metadata extracted from the main content and metadata indicating a state of a user, selecting sub-content whose characteristic information created on the basis of metadata extracted from the sub-contents is judged as closest to the recommendation information, and simultaneously reproducing or recording the main content and the sub-content (see, for example, JP-A-2006-119178).

### SUMMARY OF THE INVENTION

However, in the invention of JP-A-2006-119178, in order to select sub-content suitable for the main content, metadata of the sub-content and metadata of the main content are not directly used. Processing for creating recommendation information from metadata extracted from the main content and metadata indicating a state of a user needs to be performed. Moreover, processing for creating characteristic information on the basis of metadata obtained from sub-contents needs to be performed. Therefore, it is conceivable that the structure of an apparatus is complicated.

The metadata of the main content and the sub-contents are converted into the recommendation information and the characteristic information. Therefore, depending on accuracy of the conversion, it is likely that sub-content not expected by the user is reproduced or recorded.

Therefore, it is desirable to make it possible to continuously reproduce contents without causing a sense of discomfort to the user.

According to an embodiment of the present invention, there is provided an information processing apparatus that controls reproduction of first content and second content to simultaneously reproduce the contents. The information processing apparatus includes first reproduction control means for controlling reproduction of the first content, selecting means for selecting, from first metadata attached to the first content, first theme metadata representing a theme of the first content and the second content to be reproduced, second reproduction control means for controlling reproduction of the second content when the first theme metadata and second metadata attached to the second content are the same, and comparing means for comparing second theme metadata selected by the selecting means from metadata of the second metadata different from the first theme metadata and third metadata attached to third content. The first reproduction control means controls reproduction of the third content when the second theme metadata and the third metadata are the same.

Preferably, the comparing means compares the first theme metadata and the second metadata and compares the second theme metadata and fourth metadata attached to fourth content. The second reproduction control means controls reproduction of the fourth content when the second theme metadata and the fourth metadata are the same.

Preferably, the first content is sound and the second content is a moving image or a still image.

Preferably, the first content is a moving image or a still image and the second content is sound.

Preferably, the information processing apparatus further includes retrieving means for retrieving metadata same as the first theme metadata from the second metadata attached to the second content, creating means for creating, from a result of the retrieval, a list including specific information for specifying the second content attached with the second metadata same as the first theme metadata and the second metadata attached to the second content specified by the specific information, and sorting means for sorting the specific information in the list according to the second metadata. The second reproduction control means controls reproduction of the second content such that the second content is reproduced in order of the sorted specific information.

Preferably, the sorting means sorts the specific information such that the second content attached with only the second metadata same as the first theme metadata is reproduced earlier.

Preferably, the selecting means selects theme candidate metadata as candidates of the second theme metadata out of the second metadata of the second content attached with the second metadata same as the first theme metadata and attached with plural metadata. The sorting means sorts the specific information such that the second content attached with the theme candidate metadata is reproduced later.

Preferably, the sorting means sorts the specific information such that the second content attached with the theme candidate metadata and having a larger number of the attached second metadata is reproduced later.

Preferably, the second reproduction control means controls reproduction of the second content such that, when the second content is a moving image or a still image, the second metadata attached to the second content is displayed as a text together with the moving image or the still image.

According to another embodiment of the present invention, there is provided an information processing method for an information processing apparatus for controlling reproduction of first content and second content to simultaneously reproduce the contents. The information processing method includes a first reproduction controlling step of controlling reproduction of the first content, a selecting step of selecting, from first metadata attached to the first content, first theme metadata representing a theme of the first content and the second content to be reproduced, a second reproduction controlling step of controlling reproduction of the second content when the first theme metadata and second metadata attached to the second content are the same, and a comparing step of comparing second theme metadata selected in the selecting step from metadata of the second metadata different from the first theme metadata and third metadata attached to third content. In the first reproduction controlling step, reproduction of the third content is controlled when the second theme metadata and the third metadata are the same.

According to still another embodiment of the present invention, there is provided a computer program for causing a computer to perform processing for controlling reproduction of first content and second content to simultaneously reproduce the contents. The computer program causes the computer to perform processing including a first reproduction controlling step of controlling reproduction of the first content, a selecting step of selecting, from first metadata attached to the first content, first theme metadata representing a theme of the first content and the second content to be reproduced, a second reproduction controlling step of controlling reproduction of the second content when the first theme metadata and second metadata attached to the second content are the same, and a comparing step of comparing second theme metadata selected in the selecting step from metadata of the second metadata different from the first theme metadata and third metadata attached to third content. In the first reproduction controlling step, reproduction of the third content is controlled when the second theme metadata and the third metadata are the same.

According to the embodiments of the present invention, reproduction of first content is controlled, first theme metadata representing a theme of the first content and second content to be reproduced is selected from first metadata attached to the first content, reproduction of the second content is controlled when the first theme metadata and second metadata attached to the second content are the same, second theme metadata selected by selecting means from metadata of the second metadata different from the first theme metadata and third metadata attached to third content are compared, and reproduction of third content is controlled when the second theme metadata and the third metadata are the same.

As described above, according to the embodiments of the present invention, it is possible to continuously reproduce contents. In particular, according to the embodiments of the present invention, it is possible to continuously reproduce contents without causing a sense of discomfort to a user.

### BRIEF DESCRIPTION OF THE DRAWINGS

FIG. 1 is a block diagram showing the structure of functions of a content reproducing apparatus according to an embodiment of the present invention;

FIG. 2 is a flowchart for explaining processing for controlling reproduction of content;

FIG. 3 is a diagram for explaining a specific example of the processing for controlling reproduction of content;

FIG. 4 is a block diagram showing another structure of functions of the content reproducing apparatus;

FIG. 5 is a flowchart for explaining processing for controlling reproduction of content in the content reproducing apparatus in FIG. 4;

FIG. 6 is a flowchart for explaining the processing for controlling reproduction of content in the content reproducing apparatus in FIG. 4;

FIG. 7 is a diagram showing the number of metadata attached to image data;

FIG. 8 is a diagram showing the number of metadata attached to image data;

FIG. 9 is a diagram showing the number of metadata attached to image data;

FIG. 10 is a diagram showing the number of metadata attached to image data;

FIG. 11 is a diagram for explaining an example of display of theme candidate metadata; and

FIG. 12 is a block diagram showing an example of the structure of a personal computer.

### DESCRIPTION OF THE PREFERRED EMBODIMENTS

Embodiments of the present invention will be hereinafter explained. A correspondence relation between elements of the present invention and the embodiments described or shown in the specification or the drawings is described as follows. This description is a description for confirming that the embodiments supporting the present invention are described or shown in the specification or the drawings. Therefore, even if there is an embodiment that is described or shown in the specification or the drawings but is not described herein as an embodiment corresponding to an element of the present invention, this does not mean that the embodiment does not correspond to the element. Conversely, even if an embodiment is described herein as an embodiment corresponding to an element of the present invention, this does not mean that the embodiment does not correspond to elements other than the element.

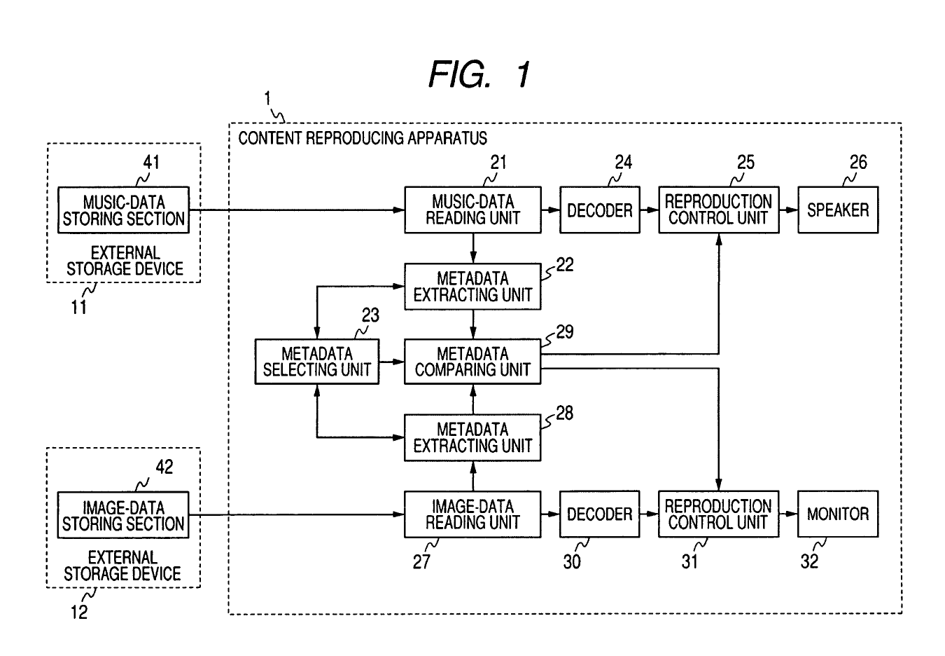

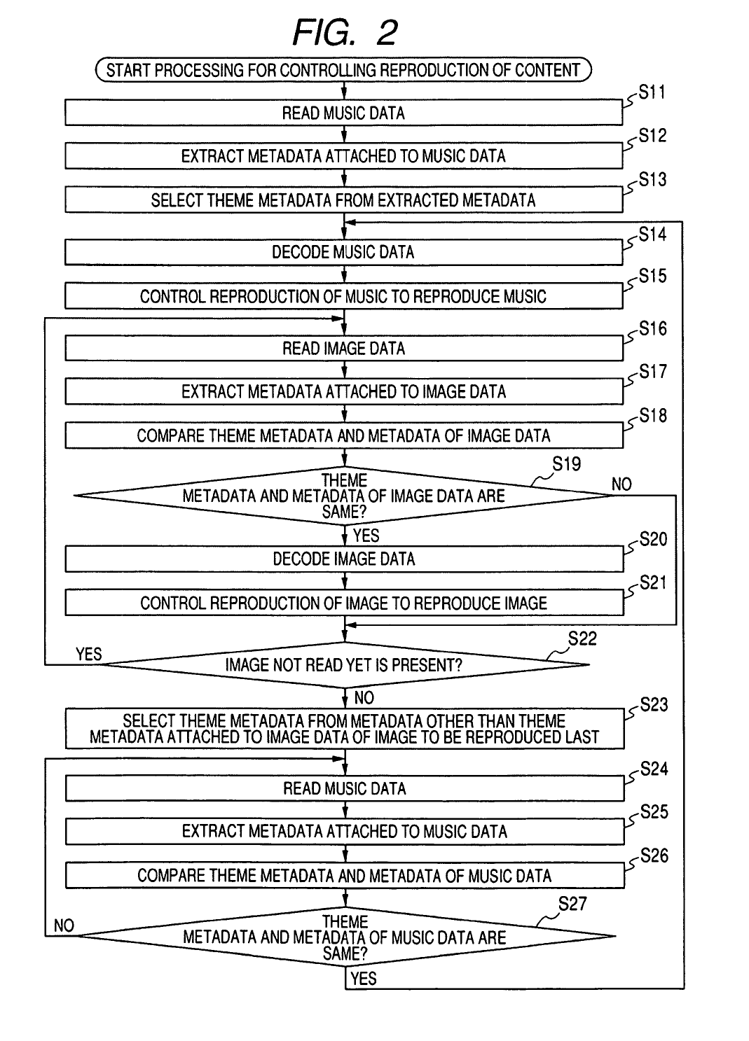

An information processing apparatus according to an embodiment of the present invention is an information processing apparatus that controls reproduction of first content and second content to simultaneously reproduce the contents. The information processing apparatus includes first reproduction control means (e.g., a reproduction control unit 25 in FIG. 1) for controlling reproduction of the first content, selecting means (e.g., a metadata selecting unit 23 in FIG. 1) for selecting, from first metadata attached to the first content, first theme metadata representing a theme of the first content and the second content to be reproduced, second reproduction control means (e.g., a reproduction control unit 31 in FIG. 1) for controlling reproduction of the second content when the first theme metadata and second metadata attached to the second content are the same, and comparing means (e.g., a metadata comparing unit 29 in FIG. 1) for comparing second theme metadata selected by the selecting means from metadata of the second metadata different from the first theme metadata and third metadata attached to third content. The first reproduction control means controls reproduction of the third content when the second theme metadata and the third metadata are the same (e.g., step S15 executed after step S27 in FIG. 2).

Preferably, the comparing means compares the first theme metadata and the second metadata (e.g., step S19 in FIG. 2) and compares the second theme metadata and fourth metadata attached to fourth content (e.g., step S26 in FIG. 2). The second reproduction control means controls reproduction of the fourth content when the second theme metadata and the fourth metadata are the same (e.g., step S15 in FIG. 2).

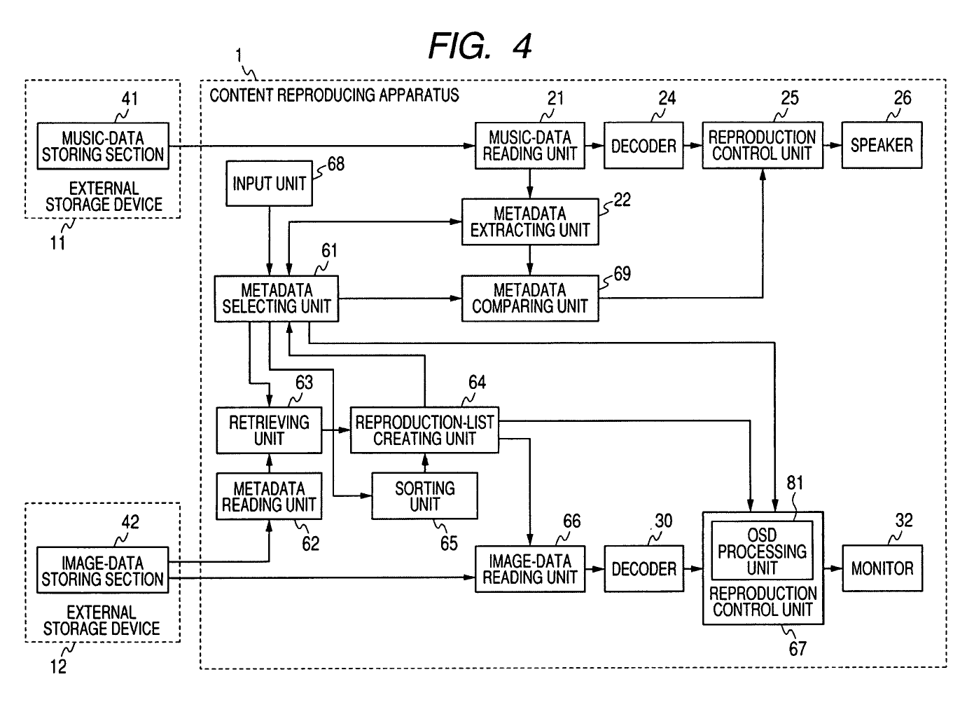

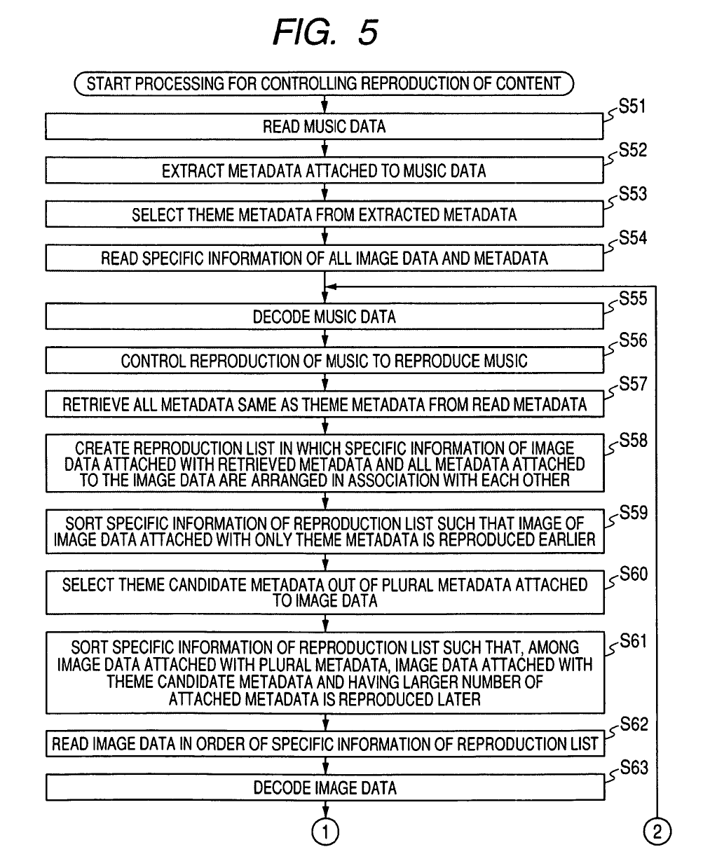

Preferably, the information processing apparatus further includes retrieving means (e.g., a retrieving unit 63 in FIG. 4) for retrieving metadata same as the first theme metadata from the second metadata attached to the second content, creating means (e.g., a reproduction-list creating unit 64 in FIG. 4) for creating, from a result of the retrieval, a list including specific information for specifying the second content attached with the second metadata same as the first theme metadata and the second metadata attached to the second content specified by the specific information, and sorting means (e.g., a sorting unit 65 in FIG. 4) for sorting the specific information in the list according to the second metadata. The second reproduction control means controls reproduction of the second content such that the second content is reproduced in order of the sorted specific information (e.g. step S64 in FIG. 5).

Preferably, the sorting means sorts the specific information such that the second content attached with only the second metadata same as the first theme metadata is reproduced earlier (e.g., step S59 in FIG. 5).

Preferably, the selecting means selects theme candidate metadata as candidates of the second theme metadata out of the second metadata of the second content attached with the second metadata same as the first theme metadata and attached with plural metadata (e.g., step S60 in FIG. 5). The sorting means sorts the specific information such that the second content attached with the theme candidate metadata is reproduced later.

Preferably, the sorting means sorts the specific information such that the second content attached with the theme candidate metadata and having a larger number of the attached second metadata is reproduced later (e.g., step S61 in FIG. 5).

Preferably, the second reproduction control means controls reproduction of the second content such that, when the second content is a moving image or a still image, the metadata attached to the second content is displayed as a text together with the moving image or the still image (e.g., step S65 in FIG. 5).

An information processing method according to another embodiment of the present invention is an information processing method for an information processing apparatus for controlling reproduction first content and second content to simultaneously reproduce the contents. The information processing method includes a first reproduction controlling step of controlling reproduction of the first content (e.g., step S15 executed after steps S13 and S14 in FIG. 2), a selecting step of selecting, from first metadata attached to the first content, first theme metadata representing a theme of the first content and the second content to be reproduced (e.g., step S13 in FIG. 2), a second reproduction controlling step of controlling reproduction of the second content when the first theme metadata and second metadata attached to the second content are the same (e.g., step S21 in FIG. 2), and a comparing step of comparing second theme metadata selected in the selecting step from metadata of the second metadata different from the first theme metadata and third metadata attached to third content (e.g., step S26 in FIG. 2). In the first reproduction controlling step, reproduction of the third content is controlled when the second theme metadata and the third metadata are the same (e.g., step S15 executed after step S27 in FIG. 2).

A computer program according to still another embodiment of the present invention is a computer program for causing a computer to perform processing for controlling reproduction first content and second content to simultaneously reproduce the contents. The computer program causes the computer to perform processing including a first reproduction controlling step of controlling reproduction of the first content (e.g., step S15 executed after steps S13 and S14 in FIG. 2), a selecting step of selecting, from first metadata attached to the first content, first theme metadata representing a theme of the first content and the second content to be reproduced (e.g., step S13 in FIG. 2), a second reproduction controlling step of controlling reproduction of the second content when the first theme metadata and second metadata attached to the second content are the same (e.g., step S21 in FIG. 2), and a comparing step of comparing second theme metadata selected in the selecting step from metadata of the second metadata different from the first theme metadata and third metadata attached to third content (e.g., step S26 in FIG. 2). In the first reproduction controlling step, reproduction of the third content is controlled when the second theme metadata and the third metadata are the same (e.g., step S15 executed after step S27 in FIG. 2).

Embodiments of the present invention will be hereinafter explained with reference to the accompanying drawings.

FIG. 1 is a block diagram showing the structure of functions of a content reproducing apparatus 1 according to an embodiment of the present invention.

The content reproducing apparatus 1 controls reproduction of music and images as content on the basis of music data and image data supplied from an external storage device 11 and an external storage device 12.

The images may be anyone of moving images and still images. The music data may be music data compressed in a predetermined system such as the AAC (Advanced Audio Coding) system or the MP3 (MPEG (Moving Picture Experts Group)-1 Audio Layer 3) system or may be uncompressed music data of the PCM (Pulse Code Modulation) system. The image data may be image data compressed in a predetermined system such as the JPEG (Joint Photographic Experts Group), JPEG 2000, MPEG2, or MPEG4 system or may be uncompressed image data of a so-called baseband system.

The external storage device 11 is, for example, a hard disk drive and includes a music-data storing section 41 as a predetermined folder on a file system that stores music data as a file or a table of a database that stores music data.

Similarly, the external storage device 12 is, for example, a hard disk drive and includes an image-data storing section 42 as a predetermined folder on a file system that stores image data as a file or a table of a database that stores image data.

The external storage device 11 and the external storage device 12 may be provided as one device. A storage device that stores music data and image data may be provided in the content reproducing apparatus 1.

The content reproducing apparatus 1 includes a music-data reading unit 21, a metadata extracting unit 22, a metadata selecting unit 23, a decoder 24, a reproduction control unit 25, a speaker 26, an image-data reading unit 27, a metadata extracting unit 28, a metadata comparing unit 29, a decoder 30, a reproduction control unit 31, and a monitor 32.

The music-data reading unit 21 is constituted as a driver of a file system or as a DBMS (Database management system). The music-data reading unit 21 reads the music data stored in the music-data storing section 41 of the external storage device 11. The music-data reading unit 21 supplies the read music data to the metadata extracting unit 22 and the decoder 24.

The metadata extracting unit 22 extracts, from the music data read by the music-data reading unit 21, metadata attached to the music data. For example, when the music data is compressed in the MP3 system, the metadata extracting unit 22 extracts metadata stored in an ID3 tag, which is an area for storing character information, by reading out the metadata. When the music data is stored in a file conforming to the MP4 file format, the metadata extracting unit 22 extracts metadata by extracting a moov box for storing the metadata. The metadata extracting unit 22 supplies the extracted metadata to the metadata selecting unit 23 and the metadata comparing unit 29.

The metadata selecting unit 23 selects, from the metadata extracted by the metadata extracting unit 22, theme metadata representing a theme of content to be reproduced. For example, the metadata selecting unit 23 selects one metadata at random out of the metadata extracted by the metadata extracting unit 22. For example, the metadata selecting unit 23 includes history information indicating metadata selected in the past.

The metadata selecting unit 23 selects, on the basis of the history information, one metadata selected at a highest frequency (or a lowest frequently) in the past or one metadata similar to the metadata out of the metadata extracted by the metadata extracting unit 22.

The metadata selecting unit 23 selects new theme metadata from metadata (metadata supplied from the metadata extracting unit 28), which is metadata other than theme metadata, attached to image data of an image to be reproduced last among images that are reproduced one after another and correspond to predetermined theme metadata.

The metadata selecting unit 23 supplies the selected theme metadata to the metadata comparing unit 29.

The decoder 24 decodes the music data supplied from the music-data reading unit 21. For example, the decoder 24 applies decoding processing to music data encoded in the MP3 system. The decoder 24 supplies the decoded music data to the reproduction control unit 25.

The reproduction control unit 25 controls reproduction of music. More specifically, the reproduction control unit 25 controls reproduction of music by supplying a music signal corresponding to the music data supplied from the decoder 24 to the speaker 26 or stopping the supply of the music signal to the speaker 26. The reproduction control unit 25 may amplify or attenuate the music signal in such a manner as to fade in or fade out music to be reproduced. When the reproduction control unit 25 controls reproduction of music corresponding to theme metadata, a start of reproduction of music is indicated from the metadata comparing unit 29 on the basis of the music data supplied from the decoder 24 and information indicating a start of reproduction of music supplied from the metadata comparing unit 29. Then, the reproduction control unit 25 causes the speaker 26 to start reproduction of music corresponding to the decoded music data supplied from the decoder 24.

The speaker 26 is a so-called loud speaker and outputs sound corresponding to the music signal supplied from the reproduction control unit 25.

The image-data reading unit 27 is constituted as a driver of a file system or as a DBMS. The image-data reading unit 27 reads the image data stored in the image-data storing section 42 of the external storage device 12. The image-data reading unit 27 supplies the read image data to the metadata extracting unit 28 and the decoder 30.

The metadata extracting unit 28 extracts metadata attached to the image data read by the image-data reading unit 27. For example, when the image data is stored in a file conforming to the MP4 file format, the metadata extracting unit 28 extracts metadata by reading out the metadata from a moov box. For example, when the image data is compressed in the MPEG2 system, the metadata extracting unit 28 extracts, as metadata, a file name of a file that stores the image data. The metadata extracting unit 28 supplies the extracted metadata to the metadata selecting unit 23 and the metadata comparing unit 29.

The metadata comparing unit 29 compares theme metadata selected from metadata of music data supplied from the metadata selecting unit 23 and the metadata of the image data supplied from the metadata extracting unit 28. More specifically, the metadata comparing unit 29 compares one theme metadata and one metadata of the image data and judges whether the theme metadata and the metadata of the image data are the same. When plural metadata are attached to the image data, the metadata comparing unit 29 compares one theme metadata and each of the plural metadata of the image data and judges whether the theme metadata and any one of the plural metadata of the image data are the same. When the metadata comparing unit 29 judges that the theme metadata and the metadata of the image data are the same, the metadata comparing unit 29 supplies information indicating a start of reproduction of images to the reproduction control unit 31.

The metadata comparing unit 29 compares theme metadata selected from the metadata of the image data supplied from the metadata extracting unit 28 and the metadata of the music data supplied from the metadata extracting unit 22. More specifically, the metadata comparing unit 29 compares one theme metadata and one metadata of the music data and judges whether the theme metadata and the metadata of the music data are the same. When plural metadata are attached to the music data, the metadata comparing unit 29 compares one theme metadata and each of the plural metadata of the music data and judges whether the theme metadata and any one of the plural metadata of the music data are the same. When the metadata comparing unit 29 judges that the theme metadata and the metadata of the music data are the same, the metadata comparing unit 29 supplies information indicating a start of reproduction of music to the reproduction control unit 25.

The decoder 30 decodes the image data supplied from the image-data reading unit 27. For example, the decoder 30 applies predetermined decoding processing to image data encoded in the MP4 file format. The decoder 30 supplies the decoded image data to the reproduction control unit 31.

The reproduction control unit 31 controls reproduction of images. More specifically, the reproduction control unit 31 controls reproduction of images by supplying an image signal corresponding to the image data supplied from the decoder 30 to the monitor 32 or stopping the supply of the image signal to the monitor 32. The reproduction control unit 31 may switch the image signal before and after switching the image being reproduced such that the image is switched at predetermined timing or may subject the image signal to signal processing in such a manner as to fade in or fade out the image to be reproduced. When the reproduction control unit 31 controls reproduction of images corresponding to theme metadata, a start of reproduction of images is indicated from the metadata comparing unit 29 on the basis of the image data supplied from the decoder 30 and the information indicating a start of reproduction of images supplied from the metadata comparing unit 29. Then, the reproduction control unit 31 causes the monitor 32 to start reproduction of images corresponding to the decoded image data supplied from the decoder 30.

The monitor 32 includes an LCD (Liquid Crystal Display), an EL (Electro Luminescence) monitor, or a plasma display and displays an image corresponding to the image signal supplied from the reproduction control unit 31.

With such a constitution, the content reproducing apparatus 1 simultaneously and continuously reproduces music and an image attached with the same metadata.

FIG. 2 is a flowchart for explaining processing for controlling reproduction of content in the content reproducing apparatus 1.

For example, when a user operates a not-shown operation unit and indicates reproduction of predetermined music, the content reproducing apparatus 1 starts processing for controlling reproduction of content.

In step S11, the music-data reading unit 21 reads the music data stored in the music-data storing section 41 of the external storage device 11. For example, the music-data reading unit 21 reads music data encoded in the MP3 system. The music-data reading unit 21 supplies the read music data to the metadata extracting unit 22 and the decoder 24.

In step S12, the metadata extracting unit 22 extracts metadata attached to the music data read by the music-data reading unit 21. For example, the metadata extracting unit 22 reads out metadata from an ID3 tag of the music data, which is encoded in the MP3 system, read by the music-data reading unit 21. The metadata extracting unit 22 supplies the extracted metadata to the metadata selecting unit 23.

In step S13, the metadata selecting unit 23 selects theme metadata from the metadata extracted by the metadata extracting unit 22. For example, the metadata selecting unit 23 selects one metadata at random out of the metadata extracted by the metadata extracting unit 22. For example, the metadata selecting unit 23 selects, on the basis of history information stored therein indicating metadata selected in the past, one metadata selected at a highest frequency in the past out of the metadata extracted by the metadata extracting unit 22. The metadata selecting unit 23 supplies the selected theme metadata to the metadata comparing unit 29.

In step S14, the decoder 24 decodes the music data supplied from the music-data reading unit 21. For example, the decoder 24 applies decoding processing to the music data encoded in the MP3 system. The decoder 24 supplies the decoded music data to the reproduction control unit 25.

In step S15, the reproduction control unit 25 controls reproduction of music to reproduce the music. More specifically, the reproduction control unit 25 supplies a music signal corresponding to the music data supplied from the decoder 24 to the speaker 26 and causes the speaker 26 to start reproduction of music.

After the reproduction control unit 25 causes the speaker 26 to start reproduction of music in step S15, while processing in steps S16 to S27 described later is executed, the reproduction control unit 25 controls the reproduction of the music to continue the reproduction of the music. In other words, the processing in steps S16 to S27 is performed in parallel to processing for the reproduction of the music. In this way, the content reproducing apparatus 1 simultaneously performs reproduction of music and reproduction of images.

In step S16, the image-data reading unit 27 reads the image data stored in the image-data storing section 42 of the external storage device 12. For example, the image-data reading unit 27 reads image data stored in a file conforming to the JP2 file format. For example, the image-date reading unit 27 reads image data stored in a file conforming to the MP4 file format. The image-data reading unit 27 supplies the read image data to the metadata extracting unit 28 and the decoder 30.

In step S17, the metadata extracting unit 28 extracts metadata attached to the image data read by the image-data reading unit 27. For example, the metadata extracting unit 28 extracts metadata by reading out the metadata from a predetermined box of the image data, which is stored in the file conforming to the JP2 file format, read by the image-data reading unit 27. For example, the metadata extracting unit 28 extracts metadata by reading out the metadata from a moov box of the image data, which is stored in the file conforming to the MP4 file format, read by the image-data reading unit 27. The metadata extracting unit 28 supplies the extracted metadata to the metadata comparing unit 29.

In step S18, the metadata comparing unit 29 compares the theme metadata supplied from the metadata selecting unit 23 and the metadata of the image data supplied from the metadata extracting unit 28. For example, when the metadata of the image data supplied from the metadata-extracting unit 28 is only one metadata, the metadata comparing unit 29 compares the theme metadata and the metadata of the only one image data. For example, when the metadata of the image data supplied from the metadata extracting unit 28 are plural metadata, the metadata comparing unit 29 compares the plural metadata of the image data with the theme metadata in order one by one.

In step S19, the metadata comparing unit 29 judges whether the theme metadata and the metadata of the image data are the same. When there are plural metadata of the image data to be compared, if the theme metadata and any one of the plural metadata of the image data are the same, the metadata comparing unit 29 judges that the theme metadata and the metadata of the image data are the same. When it is judged that the theme metadata and the metadata of the image data are the same, the metadata comparing unit 29 supplies information indicating a start of reproduction of images to the reproduction control unit 31. The processing proceeds to step S20.

In step S20, the decoder 30 decodes the image data supplied from the image-data reading unit 27. For example, the decoder 30 applies decoding processing to image data encoded in the JPEG2000 system. For example, the decoder 30 applies decoding processing to image data encoded in the MPEG4 system. The decoder 30 supplies the decoded image data to the reproduction control unit 31.

In step S21, the reproduction control unit 31 controls reproduction of images to reproduce the images. More specifically, the reproduction control unit 31 causes the monitor 32 to start reproduction of images on the basis of the image data supplied from the decoder 30 and the information indicating a start of reproduction of images supplied from the metadata comparing unit 29. The processing proceeds to step S22.

On the other hand, when it is judged in step S19 that the theme metadata and the metadata of the image data are not the same, steps S20 and S21 are skipped and the processing proceeds to step S22.

In step S22, the image-data reading unit 27 judges whether image data not read is present in the image-data storing section 42. When it is judged that image data not read is present in the image-data storing section 42, the processing returns to step S16. The processing in steps S16 to S22 is repeated for the next image data.

On the other hand, when it is judged in step S22 that image data not read is not present in the image-data storing section 42, i.e., all images attached with the metadata same as the theme metadata have been reproduced and image data of an image to be reproduced next is not present, the processing proceeds to step S23.

In step S23, the metadata selecting unit 23 selects new theme metadata from metadata other than theme metadata attached to image data of an image to be reproduced last among image data attached with theme metadata at that point. For example, the metadata selecting unit 23 selects one metadata, which is not theme metadata, at random from the metadata attached to the image data of the image to be reproduced last. For example, the metadata selecting unit 23 selects, on the basis of history information stored therein indicating metadata selected in the past, one metadata selected at a highest frequency in the past out of the metadata attached to the image data of the image to be reproduced last. The metadata selecting unit 23 supplies the metadata selected as theme metadata anew among the metadata attached to the image data of the image to be reproduced last to the metadata comparing unit 29.

In step S24, the music-data reading unit 21 reads music data stored in the music data storing section 41 of the external storage device 11. For example, the music-data reading unit 21 reads music data encoded in the MP3 system. The music-data reading unit 21 supplies the read music data to the metadata extracting unit 22 and the decoder 24.

In step S25, the metadata extracting unit 22 extracts metadata attached to the music data read by the music-data reading unit 21. For example, the metadata extracting unit 22 reads out metadata from an ID3 tag of the music data, which is encoded in the MP3 system, read by the music-data reading unit 21. The metadata extracting unit 22 supplies the extracted metadata to the metadata comparing unit 29.

In step S26, the metadata comparing unit 29 compares the theme metadata selected anew by the metadata selecting unit 23 and the metadata of the music data supplied from the metadata extracting unit 22. For example, when the metadata of the music data supplied from the metadata extracting unit 22 is only one metadata, the metadata comparing unit 29 compares the theme metadata and the only one metadata of the music data. For example, when the metadata of the music data supplied from the metadata extracting unit 22 are plural metadata, the metadata comparing unit 29 compares the plural metadata of the music data with the theme metadata in order one by one.

In step S27, the metadata comparing unit 29 judges whether the theme metadata and the metadata of the music data are the same. When there are plural metadata of the music data to be compared, if the theme metadata and anyone of the plural metadata of the music data are the same, the metadata comparing unit 29 judges that the theme metadata and the metadata of the music data are the same. When it is judged that the theme metadata and the metadata of the music data are the same, the metadata comparing unit 29 supplies information indicating a start of reproduction of music to the reproduction control unit 25. The processing returns to step S14. In step S14, the reproduction control unit 25 causes the speaker 26 to stop reproduction of music that has been reproduced and start reproduction of music corresponding to the theme metadata selected anew. The processing after step S14 is repeated.

On the other hand, when it is judged in step S27 that the theme metadata and the metadata of the music data are not the same, the processing returns to step S24. Until music data of music corresponding to the theme metadata selected anew is read, the processing in steps S24 to S27 is repeated. In this case, the reproduction control unit 25 causes the speaker 26 to continue reproduction of music that has been reproduced.

As described above, the content reproducing apparatus 1 can more easily associate music and an image to be reproduced and simultaneously reproduce the music and the image continuously by comparing metadata attached to the music and metadata attached to the image.

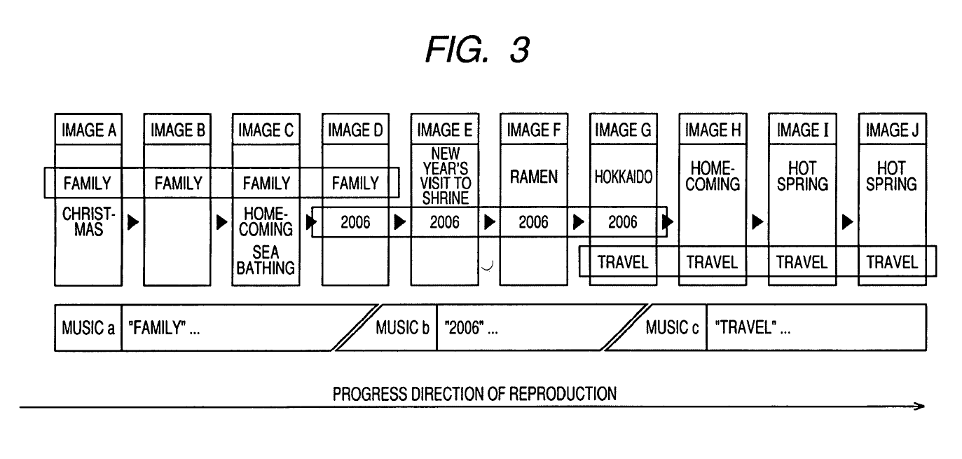

FIG. 3 is a diagram for explaining a specific example of processing for controlling reproduction of content in the content reproducing apparatus 1.

Images A to J to be reproduced by the reproduction control unit 31 are shown on an upper side of FIG. 3. As shown in FIG. 3, metadata “family” and metadata “Christmas” are attached to image data of the image A. Metadata “family” is attached to image data of the image B. Metadata “family”, metadata “homecoming”, and metadata “sea bathing” are attached to image data of the image C. Metadata “family” and metadata “2006” are attached to image data of the image D. Metadata “New Year's visit to a shrine” and metadata “2006” are attached to image data of the image E. Metadata “ramen” and metadata “2006” are attached to image data of the image F. Metadata “Hokkaido”, metadata “2006”, and metadata “travel” are attached to image data of the image G. Metadata “homecoming” and metadata “travel” are attached to image data of the image H. Metadata “hot spring” and metadata “travel” are attached to image data of the image I. Metadata “hot spring” and metadata “travel” are attached to image data of the image J.

Music “a” to music “c” reproduced by the reproduction control unit 25 are shown on a lower side of FIG. 3. As shown in FIG. 3, metadata including metadata “family” is attached to music data of the music “a”. Metadata including metadata “2006” is attached to music data of the music “b”. Metadata including metadata “travel” is attached to music data of the music “c”.

An arrow in a lower part of FIG. 3 indicates a progress direction of reproduction of content (a time direction). Music and an image as contents shown in FIG. 3 are reproduced in order from the left to the right.

For example, when the not-shown operation unit is operated by the user and reproduction of the music “a” is indicated, the music-data reading unit 21 reads out the music data of the music “a” from the music-data storing section 41. The metadata extracting unit 22 extracts the metadata attached to the read-out music data of the music “a”. The metadata selecting unit 23 selects “family”, which is one of the extracted metadata, as theme metadata. The reproduction control unit 25 causes the speaker 26 to start reproduction of the music “a”.

The image-data reading unit 27 reads out the image data of the image A from the image-data storing section 42. The metadata extracting unit 28 extracts the metadata “family” and the metadata “Christmas” attached to the image data of the image A. The metadata comparing unit 29 compares the theme metadata “family” and the metadata “family” and “Christmas” of the image A. Since the theme metadata “family” and the metadata “family” of the image A are the same, the reproduction control unit 31 causes the monitor 32 to start reproduction of the image A. At this point, the music “a” and the image A are simultaneously reproduced.

When a predetermined time elapses after the reproduction of the image A is started, the image-data reading unit 27 reads out the image data of the image B from the image-data storing section 42. The metadata extracting unit 28 extracts the metadata “family” attached to the image data of the image B. The metadata comparing unit 29 compares the theme metadata “family” and the metadata “family” of the image B. Since the theme metadata “family” and the metadata “family” of the image B are the same, the reproduction control unit 31 causes the monitor 32 to stop the reproduction of the image A and start reproduction of the image B. At this point, the music “a” and the image B are simultaneously reproduced.

Thereafter, the image C attached with the metadata “family”, the metadata “homecoming”, and the metadata “sea bathing” and the image D attached with the metadata “family” and the metadata “2006” are reproduced one after another in the same manner. While the image C and the image D are reproduced, since the reproduction of the music “a” is continued, the image C or the image D is reproduced together with the reproduction of the music “a”.

As described above, after the reproduction control unit 31 causes the monitor 32 to start reproduction of images, if an image not yet read is present, the image-data reading unit 27 reads image data from the image-data storing section 42 one after another. When the metadata “family” is attached to none of all image data read after the image data of the image D, the metadata selecting unit 23 selects, as theme metadata, the metadata “2006” attached to the image data of the image D being reproduced last among the images attached with the metadata “family” before the reproduction of the image D ends. At this point, the music “a” and the image D still continue to be reproduced.

After “2006” is selected as the theme metadata, the music-data reading unit 21 reads out the music data of the music “b” from the music-data storing section 41. The metadata extracting unit 22 extracts the metadata attached to the music data of the music “b”. The metadata comparing unit 29 compares the theme metadata “2006” and the metadata of the music “b”.

Since the metadata “2006” is included in the metadata of the music “b”, it is judged that the theme metadata and the metadata of the music “b” are the same. The reproduction control unit 25 causes the speaker 26 to stop the reproduction of the music “a” that has been reproduced and start reproduction of the music “b”. At this point, the music “b” and the image D are simultaneously reproduced. The reproduction control unit 25 may control the reproduction to switch the music “a” to the music “b” at predetermined timing or may control the reproduction such that the music “a” fades out and the music “b” fades in.

The image-data reading unit 27 reads out the image data of the image E from the image-data storing section 42. The metadata extracting unit 28 extracts the metadata “New Year's visit to a shrine” and the metadata “2006” attached to the image data of the image E. The metadata comparing unit 29 compares the theme metadata “2006” and the metadata “New Year's visit to a shrine” and “2006” of the image E. Since the theme metadata “2006” and the metadata “2006” of the metadata of the image E are the same, the reproduction control unit 31 causes the monitor 32 to stop the reproduction of the image D and start reproduction of the image E. At this point, the music “b” and the image E are simultaneously reproduced.

When a predetermined time elapses after the reproduction of the image E is started, the image-data reading unit 27 reads out the image data of the image F from the image-data storing section 42. The metadata extracting unit 28 extracts the metadata “ramen” and the metadata “2006” attached to the image data of the image F. The metadata comparing unit 29 compares the theme metadata “2006” and the metadata “ramen” and “2006” of the image F. Since the theme metadata “2006” and the metadata “2006” of the image E are the same, the reproduction control unit 31 causes the monitor 32 to stop the reproduction of the image E and start reproduction of the image F. At this point, the music “b” and the image F are simultaneously reproduced.

Thereafter, the image G attached with the metadata “Hokkaido”, the metadata “2006”, and the metadata “travel” is reproduced in the same manner. While the image G is reproduced, since the reproduction of the music “b” is continued, the image G is reproduced together with the reproduction of the music “b”.

As described above, after the reproduction control unit 31 causes the monitor 32 to start reproduction of images, if an image not yet read is present, the image-data reading unit 27 reads image data from the image-data storing section 42 one after another. When the metadata “2006” is attached to none of all image data read after the image data of the image G, the metadata selecting unit 23 selects, as theme metadata, the metadata “travel” attached to the image data of the image G to be reproduced last among the images attached with the metadata “2006” before the reproduction of the image G ends. At this point, the music “b” and the image G still continue to be reproduced.

After “travel” is selected as theme metadata, the music-data reading unit 21 reads out the music data of the music “c” from the music-data storing section 41. The metadata extracting unit 22 extracts metadata attached to the music data. The metadata comparing unit 29 compares the theme metadata “travel” and the metadata of the music “c”.

Since the metadata “travel” is included in the metadata of the music “c”, it is judged that the theme metadata and the metadata of the music “c” are the same. The reproduction control unit 25 causes the speaker 26 to stop the reproduction of the music “b” that has been reproduced and start reproduction of the music “c”. At this point, the music “c” and the image G are simultaneously reproduced. The reproduction control unit 25 may control the reproduction to switch the music “b” to the music “c” at predetermined timing or may control the reproduction such that the music “b” fades out and the music “c” fades in.

The image-data reading unit 27 reads out the image data of the image H from the image-data storing section 42. The metadata extracting unit 28 extracts the metadata “homecoming” and the metadata “travel” attached to the image data of the image H. The metadata comparing unit 29 compares the theme metadata “travel” and the metadata “homecoming” and “travel” of the image H. Since the theme metadata “travel” and the metadata “travel” of the image H are the same, the reproduction control unit 31 causes the monitor 32 to stop the reproduction of the image G and start reproduction of the image H. At this point, the music “c” and the image “H” are simultaneously reproduced.

When a predetermined time elapses after the reproduction of the image H is started, the image-data reading unit 27 reads out the image data of the image I from the image-data storing section 42. The metadata extracting unit 28 extracts the metadata “hot spring” and the metadata “travel” attached to the image data of the image I. The metadata comparing unit 29 compares the theme metadata “travel” and the metadata “hot spring” and “travel” of the image I. Since the theme metadata “travel” and the metadata “travel” of the image I are the same, the reproduction control unit 31 causes the monitor 32 to stop the reproduction of the image H and start reproduction of the image I. At this point, the music “c” and the image I are simultaneously reproduced.

Thereafter, the image J attached with the metadata “hot spring” and the metadata “travel” is reproduced in the same manner.

As described above, the content reproducing apparatus 1 reproduces the music “a” attached with the metadata “family” and reproduces the images A to D attached with the same metadata “family”. The content reproducing apparatus 1 starts reproduction of the music “b” attached with the metadata “2006” such that the music “a” is switched to the music “b” while the image D attached with the metadata “2006” other than the metadata “family” is reproduced. Moreover, the content reproducing apparatus 1 reproduces the music “b” attached with the metadata “2006” and reproduces the images E to G attached with the same metadata “2006”. A relation between the music “a” and the images A to D is maintained by the theme metadata “family”, a relation between the music “a” and the music “b” is maintained by the image D attached with the metadata “family” and “2006”, and a relation between the music “b” and the images D to G is maintained by the next theme metadata “2006”. Since the theme metadata is switched such that a relation between an image and music is not spoiled, the user can view and listen to contents without a sense of discomfort.

In the above explanation, the predetermined image reproduction time can be set to, for example, time from time when reproduction of images is started until the next image data attached with theme metadata is read and decoded. However, while image data is read one after another during reproduction of images corresponding to predetermined theme metadata, if a state in which image data attached with metadata same as the theme metadata is not read out continues, it is conceivable that a reproduction time of an image is non-uniform.

Thus, a reproduction time of an image may be set uniform by reading specific information for specifying each of the image data stored in the image-data storing section 42 and metadata altogether regardless of reproduction timing of the next image and writing only specific information of image data including theme metadata in a reproduction list to read only the image data including the theme metadata on the basis of the specific information. The specific information for specifying image data includes not only a file ID for specifying a file but also information representing a file name, a file capacity, a recording date and time, and the like of the image data.

In the explanation of the flowchart in FIG. 2, when metadata same as the theme metadata is attached to none of all the read image data, i.e., when all images attached with the theme metadata are being reproduced, metadata other than theme metadata attached to an image to be reproduced last is set as theme metadata. However, plural metadata are not always attached to an image being reproduced last.

Thus, in the reproduction list, the specific information of image data may be sorted such that an image attached with plural metadata is preferentially reproduced last. Moreover, theme metadata can be switched while a relation between an image and music is kept better by preferentially reproducing, among images specified by the specific information in the reproduction list, an image attached with common metadata among metadata other than the theme metadata last.

FIG. 4 is a block diagram showing another structure of functions of the content reproducing apparatus 1. In FIG. 4, components same as those shown in FIG. 2 are denoted by the same reference numerals and explanation of the components are omitted.

In FIG. 4, the content reproducing apparatus 1 includes the music-data reading unit 21, the metadata extracting unit 22, the decoder 24, the reproduction control unit 25, the speaker 26, the decoder 30, the monitor 32, a metadata selecting unit 61, a metadata reading unit 62, a retrieving unit 63, a reproduction-list creating unit 64, a sorting unit 65, an image-data reading unit 66, a reproduction control unit 67, an input unit 68, and a metadata comparing unit 69.

The metadata selecting unit 61 selects theme metadata from metadata extracted by the metadata extracting unit 22. For example, the metadata selecting unit 61 selects one metadata at random out of the metadata extracted by the metadata extracting unit 22. For example, the metadata selecting unit 61 includes history information indicating metadata selected in the past and selects, on the basis of the history information, one metadata selected at a highest frequency (or a lowest frequency) in the past or one metadata similar to the metadata out of the metadata extracted by the metadata extracting unit 22.

The metadata selecting unit 61 selects theme candidate metadata as candidates of new theme metadata out of metadata of image data attached with metadata same as the theme metadata and attached with plural metadata in the reproduction list of the reproduction-list creating unit 64 described later.

The metadata selecting unit 61 judges whether selection of the theme candidate metadata as theme metadata is indicated by the user. More specifically, the metadata selecting unit 61 judges whether information indicating that one of the theme candidate metadata is selected as theme metadata is supplied from the input unit 68 described later. When it is judged that selection of the theme candidate metadata as theme metadata is indicated by the user, the metadata selecting unit 61 selects the theme candidate metadata indicated by the user as theme metadata on the basis of the information, which is supplied from the input unit 68, indicating that one of the theme candidate metadata is selected as theme metadata. When selection of the theme candidate metadata as theme metadata is not indicated by the user, the metadata selecting unit 61 selects one of the theme candidate metadata as theme metadata according to a predetermined algorithm for deciding whether the theme candidate metadata is selected at random or first theme candidate metadata is selected.

The metadata selecting unit 61 supplies the selected theme metadata to the retrieving unit 63 and the metadata comparing unit 69 and supplies the selected theme candidate metadata to the sorting unit 65 and the reproduction control unit 67.

The metadata reading unit 62 reads each piece of specific information for specifying each of all the image data stored in the image-data storing section 42 and metadata attached to each of the image data in association with each other. The metadata reading unit 62 temporarily stores the read specific information and the metadata.

The retrieving unit 63 retrieves, on the basis of the theme metadata supplied from the metadata selecting unit 61, all metadata same as the theme metadata from the metadata read by the metadata reading unit 62. The retrieving unit 63 supplies specific information of image data attached with the retrieved metadata and all the metadata attached to the image data specified by the specific information including the retrieved metadata to the reproduction-list creating unit 64.

The reproduction-list creating unit 64 creates, from a result of the retrieval by the retrieving unit 63, a reproduction list in which the specific information of the image data attached with the retrieved metadata and all the metadata attached to the image data are arranged in association with each other. The created reproduction list is stored in the reproduction-list creating unit 64. The specific information of the image data arranged in the reproduction list is arranged in order of reproduction of images of the image data and sorted by the sorting unit 65 described later. The reproduction list is read out by the image-data reading unit 66 and the reproduction control unit 67.

The sorting unit 65 sorts the specific information in the reproduction list using the theme metadata supplied from the metadata selecting unit 61. More specifically, the sorting unit 65 sorts, on the basis of the theme metadata supplied from the metadata selecting unit 61, the specific information in the reproduction list such that an image of image data attached with only the theme metadata is reproduced earlier.

The sorting unit 65 sorts the specific information in the reproduction list such that an image attached with a larger number of metadata among image data attached with plural metadata is reproduced later. Moreover, the sorting unit 65 sorts the specific information in the reproduction list such that an image attached with theme candidate metadata and attached with a larger number of metadata among image data attached with plural metadata is reproduced later.

The image-data reading unit 66 reads out the reproduction list in which the specific information is sorted in the reproduction-list creating unit 64. The image-data reading unit 66 reads image data in order of the specific information in the read-out reproduction list. The image-data reading unit 66 supplies the read image data to the decoder 30.

The reproduction control unit 67 controls reproduction of images. More specifically, the reproduction control unit 67 controls reproduction of images by supplying an image signal corresponding to the image data supplied from the decoder 30 to the monitor 32 or stopping the supply of the image signal to the monitor 32. For example, the reproduction control unit 67 causes, on the basis of the image data supplied from the decoder 30 and the specific information read out from the reproduction list, the monitor 32 to start reproduction of images from the image attached with only the theme metadata in accordance with the order of the specific information in the reproduction list.

The reproduction control unit 67 includes an OSD (On Screen Display) processing unit 81. The reproduction control unit 67 controls reproduction of images such that theme candidate metadata is displayed together with an image being reproduced. The OSD processing unit 81 superimposes signals based on data of a text, an icon, and the like on an image signal to cause the monitor 32 to display a predetermined text, icon, and the like together with the image. For example, the OSD processing unit 81 superimposes a signal based on data of texts representing the theme candidate metadata on an image signal supplied to the monitor 32 such that the theme candidate metadata are displayed as texts together with the image being reproduced and one of the texts is selected by the user. In this case, the icon indicates the theme candidate metadata selected by the user or theme candidate metadata to be selected as theme metadata as default.

The input unit 68 supplies information indicating that the text, the icon, and the like displayed on the monitor 32 by the OSD processing unit 81 are selected by the user to the metadata selecting unit 61. For example, when any one of the texts of the theme candidate metadata displayed on the monitor 32 is selected by the user, the input unit 68 supplies information indicating that one of the theme candidate metadata is selected as theme metadata by the user to the metadata selecting unit 61.

The metadata comparing unit 69 compares the theme metadata supplied from the metadata selecting unit 61 and the metadata of the music data supplied from the metadata extracting unit 22. More specifically, the metadata comparing unit 69 compares one theme metadata and one metadata of the music data and judges whether the theme metadata and the metadata of the music data are the same. When plural metadata are attached to the music data, the metadata comparing unit 69 compares one theme metadata and each of the plural metadata of the music data and judges whether the theme metadata and any one of the plural metadata of the music data are the same. When the metadata comparing unit 69 judges that the theme metadata and the metadata of the image data are the same, the metadata comparing unit 69 supplies information indicating a start of reproduction of images to the reproduction control unit 25.

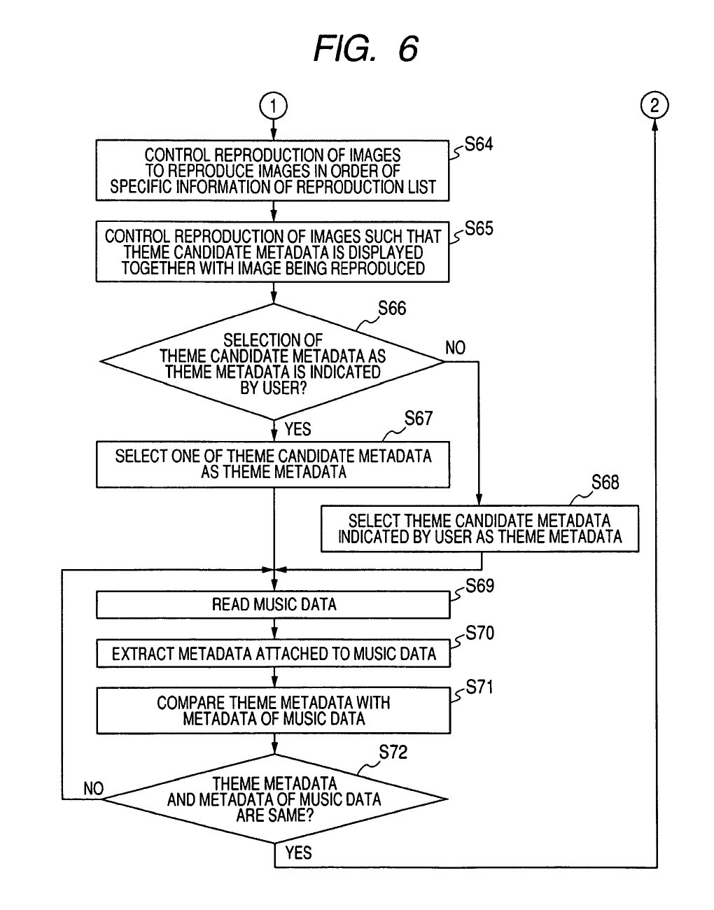

FIGS. 5 and 6 are flowcharts for explaining processing for reproduction of content in the content reproducing apparatus 1 in FIG. 4.

Processing in steps S51 and S52 in the flowchart in FIG. 5 is the same as the processing in steps S11 and S12 of the flowchart in FIG. 2. Thus, explanation of the processing is omitted.

In step S53, the metadata selecting unit 61 selects theme metadata from the metadata extracted by the metadata extracting unit 22. The metadata selecting unit 61 supplies the selected theme metadata to the retrieving unit 63 and the metadata comparing unit 69.

In step S54, the metadata reading unit 62 reads specific information and metadata of all the image data from the image-data storing section 42. More specifically, the metadata reading unit 62 reads each piece of specific information for specifying each of the image data stored in the image-data storing section 42 and metadata attached to the image data in association with each other.

If the image-data storing section 42 stores a file including the specific information and the metadata of the image data separately from the image data itself, the metadata reading unit 62 may read the file including the specific information and the metadata of the image data.

Processing in steps S55 and S56 of the flowchart in FIG. 5 is the same as the processing in steps S14 and S15 of the flowchart in FIG. 2. Thus, explanation of the processing is omitted.

In step S57, the retrieving unit 63 retrieves, on the basis of the theme metadata supplied from the metadata selecting unit 61, all metadata same as the theme metadata from the metadata read in step S54. The retrieving unit 63 supplies specific information of image data attached with the retrieved metadata and all metadata attached to the image data specified by the specific information including the retrieved metadata to the reproduction-list creating unit 64.

In step S58, the reproduction-list creating unit 64 creates a reproduction list in which the specific information of the image data attached with the retrieved metadata and all the metadata attached to the image data are arranged in association with each other.

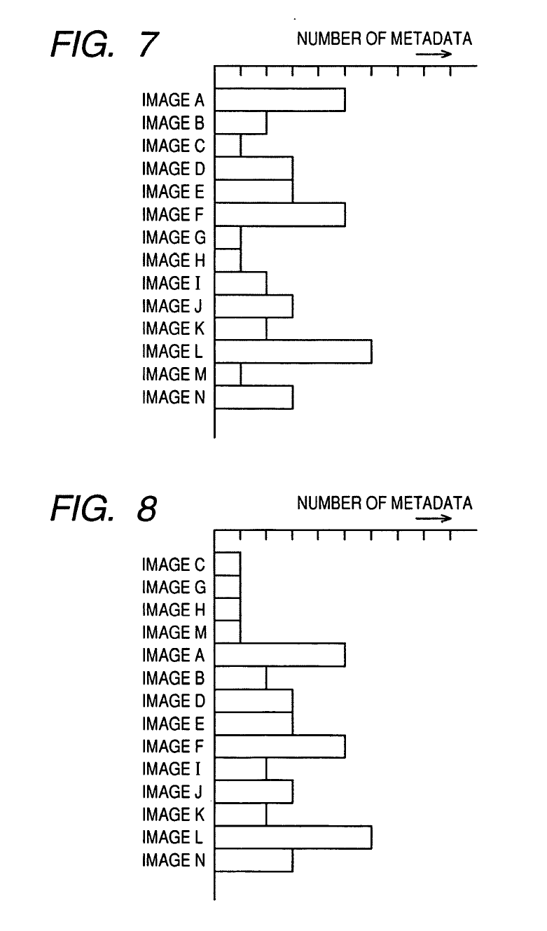

As an example, specific information and metadata of image data of each of images A to N attached with theme metadata are written in the reproduction list. This example is explained below. FIG. 7 is a diagram showing, as a bar graph, the number of metadata attached to each of the image data of the images A to N. In FIG. 7, the abscissa indicates the number of metadata attached to the image data. One scale indicates that one metadata is attached. For example, five metadata including the theme metadata are attached to the image data of the image A. Two metadata including the theme metadata are attached to the image data of the image B. Only the theme metadata is attached to the image data of the image C. In FIG. 7, image data arranged further on an upper side is reproduced earlier.

In step S59, the sorting unit 65 sorts, on the basis of the theme metadata supplied from the metadata selecting unit 61, the specific information in the reproduction list such that an image of image data attached with only the theme metadata is reproduced earlier.

FIG. 8 is a diagram showing the number of metadata of image data specified by the specific information sorted such that the image data attached with only the theme metadata is reproduced earlier.

As shown in FIG. 8, the image data of the images C, G, H, and M attached with only the theme metadata as the metadata in FIG. 7 are arranged further on an upper side. In other words, image data attached with plural metadata is reproduced later.

In step S60, the metadata selecting unit 61 selects theme candidate metadata out of the plural metadata attached to the image data.

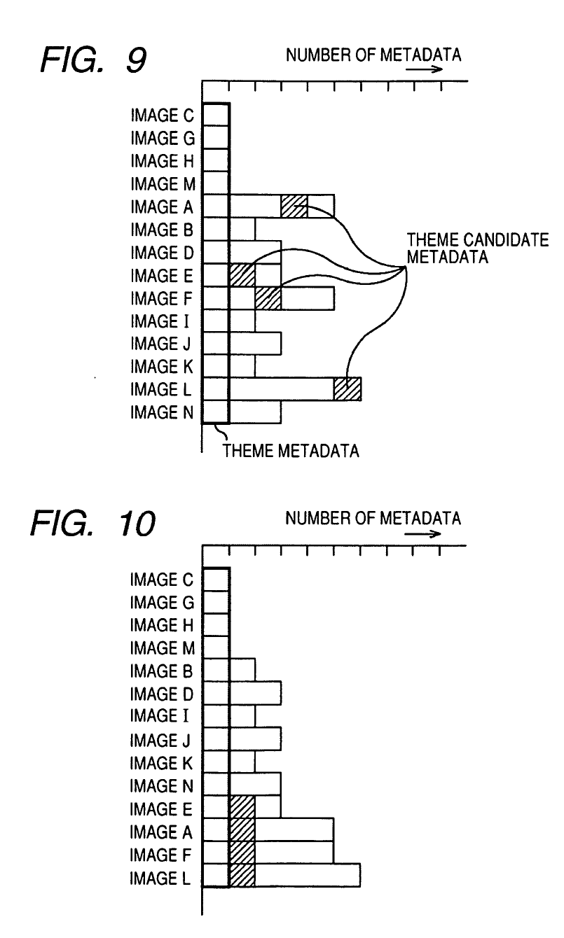

For example, as shown in FIG. 9, the image data of each of the images A to N is typically attached with one theme metadata as represented by a bold line. Common metadata other than the theme metadata is attached to the image data of the images A, E, F, and L among the image data attached with the plural metadata as represented by half-tone dot meshing.

For example, in step S60, the metadata selecting unit 61 selects the common metadata other than the theme metadata shown in FIG. 9 as theme candidate metadata to be candidates of the next theme metadata. The metadata selecting unit 61 supplies the selected theme candidate metadata to the sorting unit 65 and the reproduction control unit 67.

In the example in FIG. 9, the common metadata other than the theme metadata is one metadata. However, the common metadata may be two metadata. In this case, the metadata selecting unit 61 may select metadata common to a largest number of image data among the plural image data as theme candidate metadata or may select several metadata common to the plural image data as theme candidate metadata. In other words, theme candidate metadata to be selected may be one or may be plural. When plural theme candidate metadata are selected, for example, priority orders for selection as candidates of theme metadata may be given to the respective theme candidate metadata according to similarity to the present theme metadata.

In step S61, the sorting unit 65 sorts the specific information in the reproduction list such that, among the image data attached with the plural metadata, an image attached with the theme candidate metadata and attached with a larger number of metadata is reproduced later.

More specifically, as shown in FIG. 9, the sorting unit 65 sorts the specific information in the reproduction list such that the image data of the images A, E, F, and L attached with the theme candidate metadata are reproduced last. Moreover, as shown in FIG. 10, the sorting unit 65 sorts the specific information in the reproduction list such that, among the image data attached with the theme candidate metadata, image data attached with a larger number of metadata is reproduced later.

In step S62, the image-data reading unit 66 reads out the reproduction list in which the specific information is sorted in the reproduction-list creating unit 64 and reads the image data in order of the specific information in the reproduction list. For example, the image-data reading unit 27 reads image data stored in a file conforming to the MP4 file format in the order of the specific information in the reproduction list. The image-data reading unit 66 supplies the read image data to the decoder 30.

In step S63, the decoder 30 decodes the image data supplied from the image-data reading unit 66. For example, the decoder 30 applies decoding processing to image data encoded in the MPEG4 system in the order of the specific information in the reproduction list. The decoder 30 supplies the decoded image data to the reproduction control unit 67.

In step S64, the reproduction control unit 67 controls reproduction of images to reproduce the images in the order of the specific information in the reproduction list. More specifically, the reproduction control unit 67 supplies, on the basis of the image data supplied from the decoder 30 and the specific information read out from the reproduction list, an image signal corresponding to the image data attached with only the theme metadata to the monitor 32 according to the order of the specific information in the reproduction list and causes the monitor 32 to start reproduction of images.

The reproduction control unit 67 may control reproduction of images to reproduce the images in order of decoding in the decoder 30.

In step S65, the reproduction control unit 67 controls reproduction of images such that the theme candidate metadata is displayed together with an image being reproduced. More specifically, for example, when an image whose reproduction order is the last in the reproduction list is being reproduced, the OSD processing unit 81 of the reproduction control unit 67 superimposes, on the basis of the theme candidate metadata supplied from the metadata selecting unit 61, a signal based on data of texts representing the theme candidate metadata on the image signal supplied to the monitor 32 such that the theme candidate metadata are displayed as texts together with the image being reproduced and one of the texts is selected by the user.

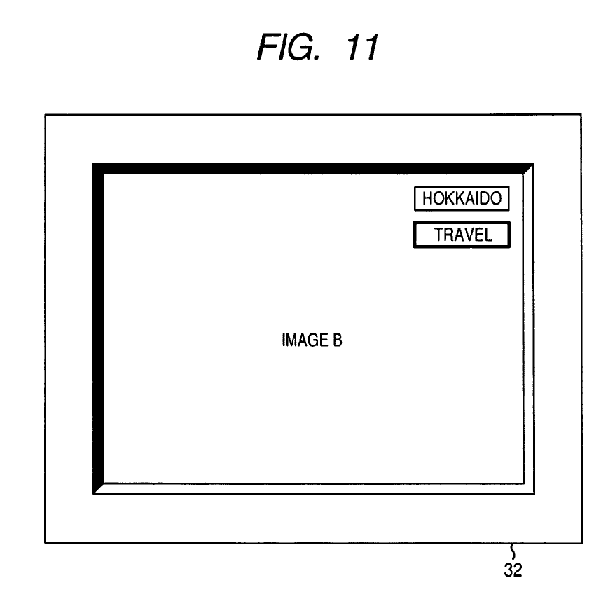

When the image whose reproduction order is the last in the reproduction list is being reproduced, for example, in the specific example in FIG. 3, when the music “b” and the image G are being reproduced, as shown in FIG. 11, texts representing the metadata “Hokkaido” and the metadata “travel”, which are the metadata attached to the image data of the image G other than the theme metadata (“2006”), are displayed on the upper right in a screen on which the image G is displayed in the monitor 32. At this point, the OSD processing unit 81 superimposes a signal based on data of the texts representing the metadata “Hokkaido” and the metadata “travel” on an image signal of the image G such that the texts representing the metadata “Hokkaido” and the metadata “travel” are displayed and any one of “Hokkaido” and “travel” is selected by the user.

An image that is being reproduced when the theme candidate metadata is displayed is not limited to the image whose reproduction order is the last in the reproduction list and may be any image attached with the theme candidate metadata.

In step S66, the metadata selecting unit 61 judges whether selection of the theme candidate metadata as theme metadata is indicated by the user. More specifically, when any one of the theme candidate metadata displayed on the monitor 32 is selected by the user, the input unit 68 supplies information indicating that one of the theme candidate metadata is selected as theme metadata by the user to the metadata selecting unit 61. The metadata selecting unit 61 judges whether the information indicating that one of the theme candidate metadata is selected as theme metadata is supplied from the input unit 68. When it is judged that selection of the theme candidate metadata as theme metadata is not indicated by the user, the processing proceeds to step S67.

In step S67, the metadata selecting unit 61 selects one of the theme candidate metadata as theme metadata. For example, the metadata selecting unit 61 selects a largest number of theme candidate metadata among the theme candidate metadata in the reproduction list as theme metadata. For example, the metadata selecting unit 61 selects, as theme metadata, theme candidate metadata having highest priority order of being selected as theme metadata out of the plural theme candidate metadata. In this case, in the same manner as a frame of the text representing the metadata “travel” indicated by a bold frame in FIG. 11, theme candidate metadata selected as theme metadata among the theme candidate metadata displayed on the monitor 32 may be highlighted. The metadata selecting unit 61 supplies the metadata selected as theme metadata anew to the metadata comparing unit 69. After step S67, the processing proceeds to step S69.

On the other hand, when it is judged in step S66 that selection of the theme candidate metadata as theme metadata is indicated by the user, the processing proceeds to step S68.

In step S68, the metadata selecting unit 61 selects, on the basis of the information indicating that one of the theme candidate metadata supplied from the input unit 68 is selected as theme metadata, the theme candidate metadata indicated by the user as theme metadata. The metadata selecting unit 61 supplies the metadata selected as theme metadata anew to the metadata comparing unit 69. After step S68, the processing proceeds to step S69.

In step S69, the music-data reading unit 21 reads the music data stored in the music-data storing section 41 of the external storage device 11. For example, the music-data reading unit 21 reads music data encoded in the MP3 system. The music-data reading unit 21 supplies the read music data to the metadata extracting unit 22 and the decoder 24.

In step S70, the metadata extracting unit 22 extracts metadata attached to the music data read by the music-data reading unit 21. For example, the metadata extracting unit 22 extracts metadata from an ID3 tag of the music data, which is encoded in the MP3 system, read by the music-data reading unit 21. The metadata extracting unit 22 supplies the extracted metadata to the metadata comparing unit 69.

In step S71, the metadata comparing unit 69 compares the theme metadata selected anew by the metadata selecting unit 61 and the metadata of the music data supplied from the metadata extracting unit 22. For example, when the metadata of the music data supplied from the metadata extracting unit 22 is only one metadata, the metadata comparing unit 69 compares the theme metadata and the only one metadata of the music data. For example, when the metadata of the music data supplied from the metadata extracting unit 22 are plural metadata, the metadata comparing unit 69 compares the plural metadata of the music data with the theme metadata in order one by one.

In step S72, the metadata comparing unit 69 judges whether the theme metadata and the metadata of the music data are the same. When there are plural metadata of the music data to be compared, if the theme metadata and any one of the plural metadata of the music data are the same, the metadata comparing unit 69 judges that the theme metadata and the metadata of the music data are the same. When it is judged that the theme metadata and the metadata of the music data are the same, the metadata comparing unit 69 supplies information indicating a start of reproduction of music to the reproduction control unit 25. The processing returns to step S55. In step S55, the reproduction control unit 25 causes the speaker 26 to stop reproduction of music that has been reproduced and start reproduction of music corresponding to the theme metadata selected anew. The processing after step S55 is repeated.

On the other hand, when it is judged in step S72 that the theme metadata and the metadata of the music data are not the same, the processing returns to step S69. Until music data of music corresponding to the theme metadata selected anew is read, the processing in steps S69 to S72 is repeated. In this case, the reproduction control unit 25 causes the speaker 26 to continue reproduction of music that has been reproduced.

As described above, while the content reproducing apparatus 1 reproduces images having a relation one after another according to theme metadata, the content reproducing apparatus 1 can reproduce images having a stronger relation based on theme candidate metadata last. Consequently, the user feels that theme metadata is switched smoothly and can view and listen to contents without a sense of discomfort.

In this way, when a slide show with music is played, the content reproducing apparatus 1 can reproduce images close to the atmosphere of the music. It is possible to easily associate the music and the images without using unnecessary information by associating the music and the images via metadata attached thereto, respectively.

Timing of the end of the reproduction of the music and the images may be, for example, time when all images of the image data stored in the image-data storing section 42 are reproduced. Alternatively, the timing may be, for example, time when the end is indicated by operation by the user. In this case, an image once reproduced is repeatedly reproduced until the end is indicated.

In the above explanation, metadata attached to music data of music to be reproduced is preferentially set as theme metadata and an image based on image data attached with the same metadata is reproduced. However, it is also possible that an image has priority over music, metadata attached to image data of an image to be reproduced is preferentially set as theme metadata, and music based on music data attached with the same metadata is reproduced.

In this way, when first content and second content are simultaneously reproduced, the contents can be continuously reproduced. An approach described below is also possible. Reproduction of the first content is controlled and first theme metadata representing a theme of the first content and the second content to be reproduced is selected from first metadata attached to the first content. When the first theme metadata and second metadata attached to the second content are the same, reproduction of the second content is controlled and second theme metadata, which is one of metadata selected by selecting means from metadata among the second metadata different from the first theme metadata, and third metadata attached to third content are compared. When the second theme metadata and the third metadata are the same, reproduction of the third content is controlled. In this case, the contents can be continuously reproduced without causing a sense of discomfort to the user.

The series of processing described above can be executed by hardware or can be executed by software. When the series of processing is executed by software, a program configuring the software is installed, from a program recording medium, in a computer built in dedicated hardware or, for example, a general-purpose personal computer that is capable of executing various functions when various programs are installed therein.

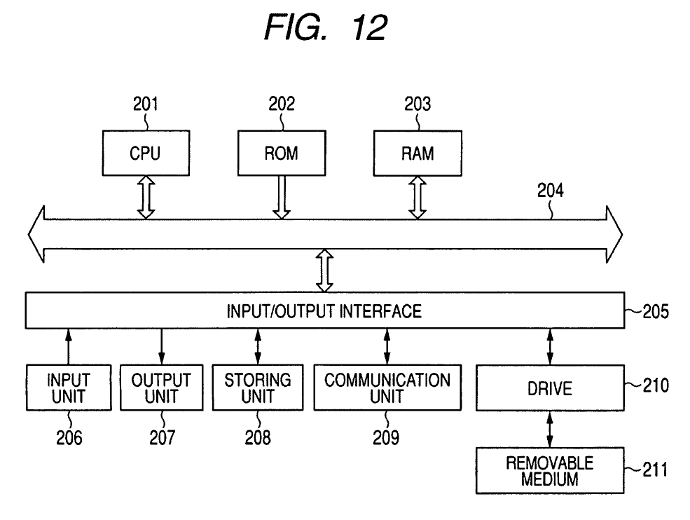

FIG. 12 is a block diagram showing an example of configuration of hardware of a personal computer that executes the series of processing according to a program.

In the computer, a CPU (Central Processing Unit) 201, a ROM (Read Only Memory) 202, and a RAM (Random Access Memory) 203 are connected to one another by a bus 204.

An input/output interface 205 is also connected to the bus 204. To the input/output interface 205, an input unit 206 including a keyboard, a mouse, and a microphone, an output unit 207 including the speaker 26 and the monitor 32, a storing unit 208 including a hard disk and a nonvolatile memory, a communication unit 209 including a network interface, and a drive 210 that drives a removable medium 211 such as a magnetic disk, an optical disk, a magneto-optical disk, or a semiconductor memory are connected.

In the computer constituted as described above, the CPU 201 loads, for example, a program stored in the storing unit 208 to the RAM 203 via the input/output interface 205 and the bus 204 and executes the program, whereby the series of processing is performed.

For example, the program executed by the computer (the CPU 201) is provided by being recorded in the removable medium 211 as a package medium including a magnetic disk (including a flexible disk), an optical disk (a CD-ROM (Compact Disc-Read Only Memory), a DVD (Digital Versatile Disc), etc.), a magneto-optical disk, or a semiconductor memory or provided via a wire or wireless transmission medium such as a local area network, the Internet, or a digital satellite broadcast.

The program can be installed in the storing unit 208 via the input/output interface 205 by inserting the removable medium 211 in the drive 210. The program can be received by the communication unit 209 via the wire or wireless transmission medium and installed in the storing unit 208. Besides, the program can be installed in the ROM 202 or the storing unit 208 in advance.

The program executed by the computer may be a program with which processing is performed in time series according to the order explained in this specification or may be a program with which processing is performed in parallel or at necessary timing such as time when the program is invoked.

In the embodiment explained above, the present invention is applied to the content reproducing apparatus. However, the present invention can also be applied to an information processing apparatus that reproduces content such as a television receiver, an HDD (Hard Disk Drive) recorder, and portable terminal apparatuses such as a PDA (Personal Digital Assistant) and a cellular phone.

Embodiments of the present invention are not limited to the embodiment described above. Various modifications of the embodiment are possible without departing from the spirit of the present invention.

It should be understood by those skilled in the art that various modifications, combinations, sub-combinations, and alterations may occur depending on design requirements and other factors insofar as they are within the scope of the appended claims or the equivalents thereof.

What is claimed is:

1. An information processing apparatus that controls reproduction of first content and second content to simultaneously reproduce the contents, the information processing apparatus comprising:
first reproduction control means for controlling reproduction of the first content;
selecting means for selecting, from first metadata attached to the first content, first theme metadata representing a theme of the first content and the second content to be reproduced;
second reproduction control means for controlling reproduction of the second content when the first theme metadata and second metadata attached to the second content are the same; and
comparing means for comparing second theme metadata selected by the selecting means from metadata of the second metadata different from the first theme metadata and third metadata attached to third content, wherein
the first reproduction control means controls reproduction of the third content when the second theme metadata and the third metadata are the same.

2. An information processing apparatus according to claim 1, wherein
the comparing means compares the first theme metadata and the second metadata and compares the second theme metadata and fourth metadata attached to fourth content, and the second reproduction control means controls reproduction of the fourth content when the second theme metadata and the fourth metadata are the same.

3. An information processing apparatus according to claim 1, wherein
the first content is sound; and
the second content is a moving image or a still image.

4. An information processing apparatus according to claim 1, wherein
the first content is a moving image or a still image, and the second content is sound.

5. An information processing apparatus according to claim 1, further comprising:
retrieving means for retrieving metadata same as the first theme metadata from the second metadata attached to the second content;
creating means for creating, from a result of the retrieval, a list including specific information for specifying the second content attached with the second metadata same as the first theme metadata and the second metadata attached to the second content specified by the specific information; and
sorting means for sorting the specific information in the list according to the second metadata, wherein
the second reproduction control means controls reproduction of the second content such that the second content is reproduced in order of the sorted specific information.

6. An information processing apparatus according to claim 5, wherein the sorting means sorts the specific in formation such that the second content attached with only the second metadata same as the first theme metadata is reproduced earlier.

7. An information processing apparatus according to claim 5, wherein
the selecting means selects theme candidate metadata as candidates of the second theme metadata out of the second metadata of the second content attached with the second metadata same as the first theme metadata and attached with plural metadata, and
the sorting means sorts the specific information such that the second content attached with the theme candidate metadata is reproduced later.

8. An information processing apparatus according to claim 7, wherein the sorting means sorts the specific information such that the second content attached with the theme candidate metadata and having a larger number of the attached second metadata is reproduced later.

9. An information processing apparatus according to claim 1, wherein the second reproduction control means controls reproduction of the second content such that, when the second content is a moving image or a still image, the second metadata attached to the second content is displayed as a text together with the moving image or the still image.

10. An information processing method for an information processing apparatus for controlling reproduction of first content and second content to simultaneously reproduce the contents, the information processing method comprising the steps of:
controlling reproduction of the first content;
selecting, from first metadata attached to the first content, first theme metadata representing a theme of the first content and the second content to be reproduced;
controlling reproduction of the second content when the first theme metadata and second metadata attached to the second content are the same; and
comparing second theme metadata selected in the selecting step from metadata of the second metadata different from the first theme metadata and third metadata attached to third content, wherein
in the step of controlling reproduction of the first content, reproduction of the third content is controlled when the second theme metadata and the third metadata are the same.

11. A computer program for causing a computer to perform processing for controlling reproduction of first content and second content to simultaneously reproduce the contents, the computer program causes the computer to perform processing comprising:
controlling reproduction of the first content;
selecting, from first metadata attached to the first content, first theme metadata representing a theme of the first content and the second content to be reproduced;
controlling reproduction of the second content when the first theme metadata and second metadata attached to the second content are the same; and
comparing second theme metadata selected in the selecting step from metadata of the second metadata different from the first theme metadata and third metadata attached to third content, wherein
in the controlling reproduction of the first content, reproduction of the third content is controlled when the second theme metadata and the third metadata are the same.

12. An information processing apparatus that controls reproduction of first content and second content to simultaneously reproduce the contents, the information processing apparatus comprising:
a first reproduction control unit configured to control reproduction of the first content;
a selecting unit configured to select, from first metadata attached to the first content, first theme metadata representing a theme of the first content and the second content to be reproduced;
a second reproduction control unit configured to control reproduction of the second content when the first theme metadata and second metadata attached to the second content are the same; and
a comparing unit configured to compare second theme metadata selected by the selecting unit from metadata of the second metadata different from the first theme metadata and third metadata attached to third content, wherein
the first reproduction control unit controls reproduction of the third content when the second theme metadata and the third metadata are the same.
